(19) United States
(12) Patent Application Publication
(10) Pub. No.: US 2026/0028280 A1
(43) Pub. Date: Jan. 29, 2026

(54) PROTECTED METAL WIRES AND FIBERS FOR REINFORCEMENT OF CONCRETE STRUCTURES

(71) Applicant: Helix Steel, LLC, Ann Arbor, MI (US)

(72) Inventors: Luke Pinkerton, Ann Arbor, MI (US); Barbara Tozier, Ann Arbor, MI (US); Robin Loetters, Hemer (DE)

(21) Appl. No.: 19/099,801

(22) PCT Filed: Aug. 8, 2023
(86) PCT No.: PCT/US2023/029694

§ 371 Date: Jan. 30, 2025

Related U.S. Application Data
(60) Provisional application No. 63/396,998, filed on Aug. 11, 2022.

(51) Int. Cl. C04B 20/00; C04B 20/10

(52) U.S. Cl. CPC C04B 20/0068; C04B 20/1062; C04B 2201/50

(57) ABSTRACT

Metal wires for use in the reinforcement of a concrete structure. The metal wires included a metal core encapsulated by a galvanized layer of zinc with a protective passivation layer applied thereon. The passivation layer protects the galvanized zinc layer from being depleted by reaction with water, thereby limiting the level of corrosion protection provided. The level of corrosion protection is determined to be satisfactory when a total of 50 grams of the metal wires produce less than or equal to 3.0 cubic centimeters (cm3) of a gas upon immersion in a 1 molar (M) potassium hydroxide solution (pH=14) for 90 minutes. The passivation layer is provided by the use of dry-drawing agents during the drawing process of the metal wires.

### FIELD

This disclosure relates generally to cementitious building materials used in the design and formation of concrete structures. More specifically, this disclosure relates to protected metal wires and fibers used as a reinforcement material in a concrete structure.

### BACKGROUND

The statements in this section merely provide background information related to the present disclosure and may not constitute prior art.

A major portion of the design, engineering, and building of concrete structures is focused on the overall stability and long life-time expectation for such structures. In this respect, the construction of concrete structures generally makes use of steel reinforcement to distribute various tension(s) that occur or exist within the structures. However, at the same time, population growth and urbanization continues to drive the need and desire to create larger structures with faster realization times.

The use of conventional metal rebar has begun to be replaced in many applications with the use of steel wires or fibers randomly mixed or dispersed within the concrete structure. In general, these reinforcing wires or fibers are stiffer than the concrete structure, are stronger in tensile strength than the concrete structure and exhibit continuous deformation, and/or enhance the bond strength between the cement paste and the other aggregates present within the paste.

Unfortunately, without some form of surface protection, such steel wires or fibers are subject to corrosion when embedded within two inches of the surface of the concrete structure that is exposed to the environment.

In comparison to standard steel wires or fibers, Helix® Micro Rebar® (Pensmore Reinforcement Technologies, Michigan) exhibits superior mechanical properties along with a relatively long storage shelf-life due to the presence of a zinc coating that protects the fibers against corrosion. However, this zinc galvanization may undergo a chemical reaction with the concrete, which limits the level of corrosion protection that can be provided

U.S. Publication No. 2011/0088596 describes a reinforced structure comprising a cementitious matrix and zinc coated metal elements. The structure comprises at least at the interface of the zinc coated metal elements and the cementitious matrix a compound selected from the group consisting of the imidazoles, the triazoles and the tetrazoles in an attempt to inhibit hydrogen gas evolution at the interface of zinc coated metal elements embedded in a cementitious matrix. However, the addition of such compounds to a glue that is applied to each of the zinc coated metal elements is difficult to manufacture and apply, while the addition of such compounds directly to the cementitious matrix reduces their ability to provide adequate protection over the entirety of the metal elements.

### SUMMARY

The present disclosure generally provides metal wires for use in the reinforcement of a concrete structure. The metal wires comprise a metal core encapsulated by a galvanized layer of zinc with a protective passivation layer applied thereon. The level of corrosion protection provided is satisfactory when a total of fifty (50) grams of these metal wires produce less than or equal to 3.0 cubic centimeters (cm³) of a gas upon immersion in a 1 molar (M) potassium hydroxide solution (pH=14) for 90 minutes. Even after these metal wires are subjected to abrasion by insertion into a rock tumbler having a 3:8 ratio of stone to water for at least 5 minutes no degradation of the protective passivation layer results. In other words, even after being subjected to abrasion, the amount of the gas produced by the wires remains less than or equal to 3.0 cm³ upon immersion in the potassium hydroxide solution.

According to one aspect of the present disclosure, the metal wires are concrete reinforcing fibers or metal wire pieces configured for dispersion or mixing into a cement paste or concrete medium. These concrete reinforcing fibers or metal wire pieces generally have an average diameter that is in the range of about 0.10 millimeters (mm) to about 2.00 mm and an average length that is less than or equal to 150 mm. When desirable, the concrete reinforcing fibers or metal wire pieces are twisted steel micro-reinforcement (TSMR) specifically manufactured for use in providing reinforcement to concrete structures, i.e., are configured for dispersion or mixing into a cement paste or concrete medium.

The protective passivation layer comprises at least one dry-drawing agent that is sodium-based or calcium-based, such that reaction of the underlying zinc galvanization layer with water is minimized or reduced. During the pouring of the concrete structure, a total of fifty (50) grams of the metal wires generate less than 3.0 cm³ of hydrogen (H₂) gas upon immersion into the cement paste or concrete medium indicating the passivation has occurred with optimal corrosion resistance.

In addition, the metal wires allow the reinforced concrete to perform equal to or better than plain concrete in at least one of compressive testing (ASTM C39), flexural testing (ASTM C78), residual strength testing (ASTM C1399), post-crack beam testing (ASTM C1609), and freeze thaw testing (ASTM C666). The metal wires also allow the reinforced concrete to perform equal to or better than conventional concrete reinforcing fibers in direct tension testing.

According to another aspect of the present disclosure, the metal wires exhibit a reduced rate of corrosion upon exposure to one or more of a lime/water mixture, tap water, a CaCl solution or a NaCl solution that is at least 5% less than the rate of corrosion exhibited by conventional uncoated steel wires, copper coated steel wires, or zinc-plated steel wires exposed to the same or identical conditions.

According to yet another aspect of the present disclosure, a process of manufacturing galvanized metal wires is provided. This process generally comprises: forming metal wires having an external uncoated surface; treating the external uncoated surface of the metal wires via electroplating or hot-dip galvanization, such that a layer of zinc is formed thereon; and depositing a protective passivation layer on top of the layer of zinc. The depositing of the protective passivation layer may be done in-line with forming the metal wires and treating the external uncoated surface as a continuous process during the manufacturing of the metal wires.

During the process of forming the metal wires at least one dry-drawing agent that is sodium-based or calcium-based is deposited as the protective passivation layer. The at least one dry-drawing agent may be deposited onto the zinc layer upstream of any forming process used in the manufacturing process.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a graphical representation of the corrosion rate exhibited by zinc metal plotted as a function of the pH of the environment to which the zinc metal is exposed;

FIG. 2 is a cross-sectional schematic of the metal wires formed according to the teachings of the present disclosure illustrating the layered structure desirable to limit corrosion thereof;

FIG. 3 is a flowchart of a process used according to the teachings of the present disclosure to reduce or limit the corrosion of the metal wires of FIG. 2;

FIG. 4 is a diagram of a test set-up used to measure the integrity of a zinc galvanization layer applied to metal wires or fibers;

FIG. 5 is a visual depiction comparing the degree of corrosion that occurs for conventional steel wire having a galvanized zinc layer; a steel wire having a copper coating, and a metal wire including a galvanized zinc layer protected according to the teachings of the present disclosure upon exposure to tap water; and

FIG. 6 is a visual depiction comparing the degree of corrosion that occurs for conventional steel wire having a galvanized zinc layer; a steel wire having a copper coating, and a metal wire including a galvanized zinc layer protected according to the teachings of the present disclosure upon exposure to a salt (NaCl) solution.

The drawings described herein are for illustration purposes only and are not intended to limit the scope of the present disclosure in any way.

### DETAILED DESCRIPTION

The following description is merely exemplary in nature and is in no way intended to limit the present disclosure or its application or uses. It should be understood that throughout the description, corresponding reference numerals indicate like or corresponding parts and features.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

The objective of the present disclosure is to remedy the aforementioned disadvantages and to provide protected steel fibers or wires that resist corrosion when used in a concrete structure. Zinc is the typical base metal commonly used to provide protection for steel products against corrosion for short-term periods of time. Zinc metal tends to react very quickly with oxygen upon exposure to the atmosphere. The conversion of zinc metal to zinc oxide slows down the occurrence of any further corrosion at the surface of the zinc metal. This self-passivation is similar to how the formation of iron oxide (e.g., rust) on the surface of a steel structure passivates or slows down the occurrence of any further corrosion to the underlying steel structure. However, since oxygen tends to react faster with zinc as compared to the iron present in the zinc-coated steel fibers, small defects in the overlying zinc coating may passivate or provide protection to the underlying steel fibers. Unfortunately, the high potential for undergoing oxidation, leads to reactions of zinc with alkaline media, such as NaOH or the like, which can result in the production of hydrogen (H₂) gas as shown in Equation 1 below resulting in a poor passivation layer crystalline structure, which provides poor corrosion protection, or even dissolution of the zinc coating entirely.

$${Zn}^{0} + 2 {H}_{2} O + 2 {OH}^{-} \to {[ {Zn ( OH )}_{4} ]}^{2 -} + {H}_{2} ↑ \qquad ( Eq . 1 )$$

The zinc-depletion reaction described above in Equation 1 produces hydrogen gas and renders the unprotected zinc to be at a high risk of becoming depleted, thereby eliminating the corrosion protection that the zinc provides. Passivation as provided by the teachings of the present disclosure, reduces this effect.

One of the most critical phases in constructing a concrete structure is the pouring of the concrete itself. During this period, the concrete reaches temperatures that enable the formation of gases that may migrate within the uncured mixture to the external surface of the concrete and/or to other locations within the concrete structure. According to one aspect of the present disclosure, various ways to provide passivation for a zinc coating in order to protect the zinc coating from being consumed during this critical phase in the construction of a concrete structure is provided.

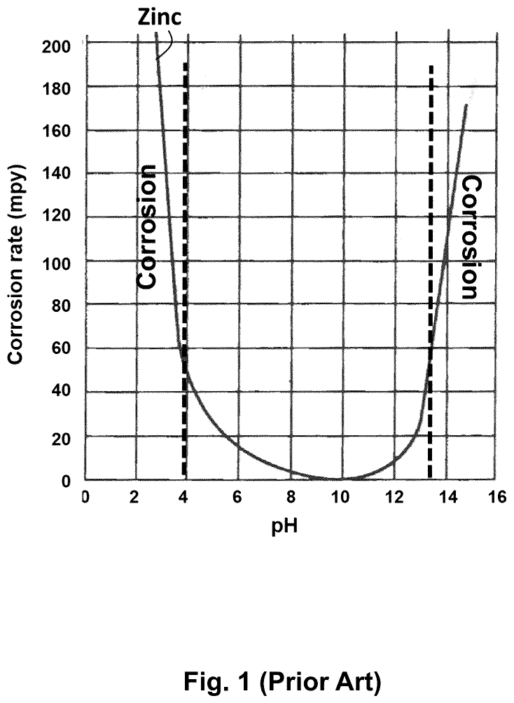

Referring now to FIG. 1, zinc may undergo corrosion when the pH of the environment to which the zinc is exposed is either high (e.g., ≥13.5) or low (e.g., ≤4). Thus, unprotected zinc-plated steel, under certain circumstances when the pH of the concrete is high or low may corrode, e.g., react. In other words, depending on the pH of the concrete, the zinc coating will either self-passivate and stop reacting, or the zinc will be consumed. Generally, concrete has a pH of 13.7 or lower—at this pH the zinc may self-passivate. However, in some instances when the pH is higher, the zinc coating can react and evolve hydrogen gas from the surface of the metal, thereby reducing its corrosion resistance. A reduction in the corrosion resistance of the steel reinforcement in concrete generally results in a reduction in overall performance of the concrete.

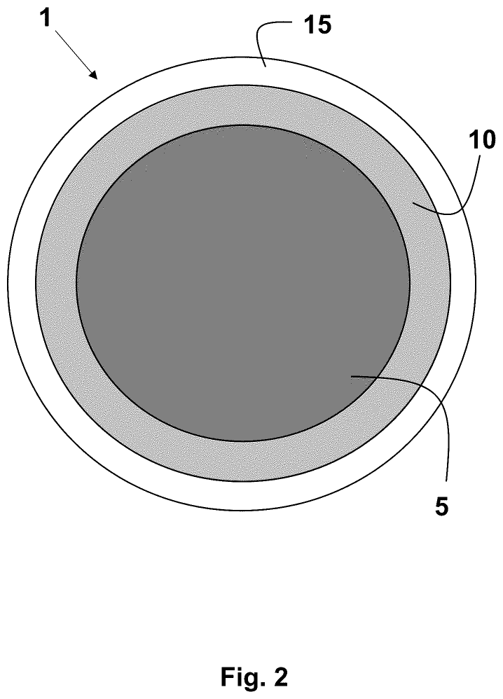

According to one aspect of the present disclosure, such reaction is inhibited from occurring, even after abrasion of the surface of the steel wires or fibers. Referring now to FIG. 2, the metal wires 1 generally comprise a metal core 5 encapsulated by a galvanized layer of zinc 10 with a protective passivation layer 15 applied thereon. The protective passivation layer 15 may be deposited on at least a portion of the galvanized zinc layer 10 or alternatively, substantially cover the surface of the galvanized zinc layer 10. The level of corrosion protection is determined to be satisfactory when a total of fifty (50) grams of these metal wires 1 produce less than or equal to 3.0 cubic centimeters (cm³) of a gas upon immersion in a 1 molar (M) potassium hydroxide solution (pH=14) for 90 minutes. Even after these metal wires 1 are subjected to abrasion by insertion into a rock tumbler having a 3:8 ratio of stone to water for at least 5 minutes no degradation of the protective passivation layer results. In other words, even after being subjected to abrasion, the amount of the gas produced by the wires 1 remains less than or equal to 3.0 cm³ upon immersion in the potassium hydroxide solution.

The process of forming the protected metal wires or fibers presented herein is nontoxic (e.g. it does not involve chemicals such as hexavalent chrome, which is commonly used in conventional passivation processes and have been shown to be carcinogenic). In addition, the process may utilize either a batch or a continuous method to passivate or protect the surface of galvanized metal wires or fibers. However, the use of a batch treatment process can be costly and time consuming, as well as requiring the use of toxic coating precursor materials. In comparison, continuous treatment during wire manufacturing or during the manufacturing of steel fibers is more cost effective given that it can be conducted in-line with the wire or fiber manufacturing process.

The manufacturing of a metal wire or fiber is generally designed to achieve a desired tensile strength. In order to achieve such a desired tensile strength it is necessary to find the right combination of carbon-content and deformation in the drawing of the wire. The amount of deformation may be adjusted by either increasing or decreasing the diameter of the intermediate product formed in this wire drawing process. In addition, having a lower carbon contact in the wire or fiber may be compensated for by increasing the diameter of this intermediate product and vice versa.

The changing of the diameter for the intermediate product also has an impact on the selection of several other production parameters, as well as the quality of the final wire or fiber product. A larger diameter and/or a higher reduction grade eventually requires the use of additional drawing dies in the drawing process, as well as further lubrication and/or an increase in the drawing force that is applied. In comparison, working with an intermediate product having a smaller diameter leads to a substantially higher inlet speed, which may cause pay-off problems to occur during production. In addition, the use of an intermediate product having a smaller diameter in the drawing process may also result in less reduction of the zinc coating. Since the galvanizing process applies the same amount of coating material to the intermediate product independent of the diameter associated therewith, less reduction in the drawing process can result in a greater thickness of zinc coating being applied to intermediate products that have a smaller diameter.

According to one aspect of the present disclosure, the metal wires are concrete reinforcing fibers or metal wire pieces configured for dispersion or mixing into a cement paste or concrete medium. These concrete reinforcing fibers or metal wire pieces generally have an average diameter that is in the range of about 0.10 millimeters (mm) to about 2.00 mm and an average length that is less than or equal to 150 mm. Alternatively, the average diameter of the concrete reinforcing fibers or metal wire pieces may be in the range of 0.25 mm to about 1.00 mm alternatively, greater than 0.33 mm and less than .0.75 mm; alternatively, about 0.50 mm. Similarly, the average length of these wire pieces or concrete reinforcing fibers may alternatively be less than about 100 mm; alternatively, in the range of about 5 mm to about 50 mm: alternatively, about 25 mm. When desirable, the concrete reinforcing fibers or metal wire pieces may be twisted steel micro-reinforcement (TSMR) specifically manufactured for use in providing reinforcement to concrete structures, i.e., are configured for dispersion or mixing into a cement paste or concrete medium. During the pouring of a concrete structure, a total of fifty (50) grams of the metal wires in the form of concrete reinforcing fibers, wire pieces, or TSMR should generate less than 3.0 cm³ of hydrogen (H₂) gas upon immersion into the cement paste or concrete medium in order to provide satisfactory corrosion protection.

In addition, the metal wires allow the reinforced concrete to perform equal to or better than plain concrete in at least one of compressive testing (ASTM C39), flexural testing (ASTM C78), residual strength testing (ASTM C1399), post-crack beam testing (ASTM C1609), and freeze thaw testing (ASTM C666). The metal wires also allow the reinforced concrete to perform equal to or better than conventional concrete reinforcing fibers in direct tension testing. Alternatively, the concrete reinforced with the metal wires protected according to the teachings of the present disclosure exhibit performance at least as equivalent to plain concrete in each of the test described above.

Since the zinc galvanization layer or coating is involved may undergo reactions that result in a reduced level of corrosion protection during the pouring of the concrete medium to form the concrete structure, the formation of the zinc surface during the drawing process is a key parameter for reducing such gas formation below a critical value.

According to one aspect of the present disclosure, the formation of gas may be inhibited by providing a protective passivation layer to the zinc galvanization layer by either i) applying a temporary protective substance, such as an oil, onto the surface of the zinc layer or ii) encapsulating the surface of the zinc layer with a chemically-derived coating. Protective substances are usually used to protect the zinc layer temporarily during storage and transportation, while the application of a chemically-derived coating may alter the surface chemistry and provide a more long-term effect.

The application of a protective passivation layer in the form of a chemically-derived coating should be done at or near the final production step of the manufacturing process. In sheet metal production, coating application may be accomplished in-line with sheet metal production speeds running up to about 250 m/min (˜ 4 m/s). However, coating application during the final drawing of fine steel wires would be difficult to accomplish without reducing the speed to a totally uneconomical level. Typical production speeds for steel wire start at about 10 m/s and can reach up to 30+m/s in a modern production process.

The application of protective substances, such as oils is difficult to achieve at the high production speeds utilized in the drawing process for fine steel wires. In addition, the application of oils tend to also have limited adhesion to the substrate and may have a negative effect on the forming process associated with twisted steel micro-rebar (TSMR), such as Helix® Micro Rebar® (Pensmore Reinforcement Technologies, Michigan).

In order to avoid the issues associated with applying a protective substance, e.g., oils, and to provide an economical way of applying a protective layer to the surface of the zinc passivation layer, the process of the present disclosure incorporates the application of the protective layer into the drawing process itself. In this respect, the incorporation of at least one dry-drawing agent into the drawing process has shown to provide a high level of adhesion and establish an effective barrier against short-term oxidation of the surface of the zinc passivation layer. In comparison, typical “wet” lubricants exhibit behavior similar to standard protective substances, such as oils.

Dry-drawing agents used in the redrawing process of metal (e.g., steel) wires or fibers according to the teachings of the present disclosure may be sodium-based, calcium-based, or a mixture thereof. Alternatively, a mixture of dry-drawing agents may be used at any desired ratio, including without limitation, 80:20, 60:40, or 20:80 for a mixture of two dry-drawing agents. When desirable, a mixture of more than two dry-drawing agents may be used. The use of such dry-drawing agents has been found to combine the positive effect of process stability and passivation of the zinc surface in a desirable way. The dry-drawing agents may be applied through the use of a standard dry-drawing box positioned or mounted at the inlet of the drawing equipment.

The use of such dry-drawing agents incorporates the positive aspects of wire drawing (e.g., high speeds, low tooling costs, relatively low energy consumption, etc.) with the enhanced application of the specified drawing agent to passivate the surface of the zinc galvanization layer. Drawing speeds of 30+m/s may also reduce the overall investment required when setting up a new production facility.

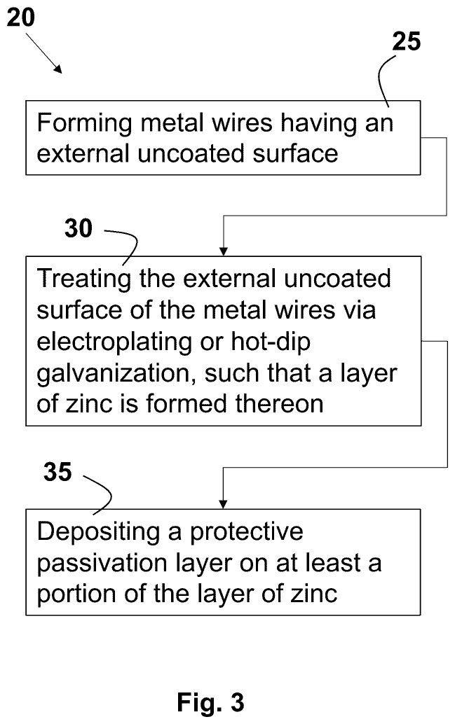

Referring now to FIG. 3, a process 20 of manufacturing galvanized metal wires is provided. This process 20 generally comprises: forming 25 metal wires having an external uncoated surface; treating 30 the external uncoated surface of the metal wires via electroplating or hot-dip galvanization, such that a layer of zinc is formed thereon; and depositing 35 a protective passivation layer onto at least a portion of the layer of zinc: alternatively, substantially covering the galvanized zinc layer. The depositing 35 of the protective passivation layer may be done in-line with forming 25 the metal wires and treating 30 the external uncoated surface as a continuous process during the manufacturing of the metal wires.

The application of the dry-drawing agents may be accomplished by implementing a skin-pass step located in front of or upstream of any “forming” process utilized in forming twisted steel micro-rebar (TSMR), such as Helix® Micro Rebar®. In this case, only a dry-drawing box is necessary along with a cooling device configured to control the die temperature. On one hand the life-time of a die may be increased by cooling the die, on the other hand a certain temperature is necessary in order to apply the dry-drawing agent to the wire. In this process, the dry-drawing agent may be melted in the conical inlet of the die. The use of a pressure die may provide for process optimization when synchronization exists with the forming process. In this case, the pinch rollers in the forming process may be used to pull the wire, while the pressure die provides the desired level of dry-drawing agent to the surface of the zinc passivation.

During the pouring of the concrete. it is necessary to keep the intrusion of gases (i.e., air, H₂, etc.) into the cement paste or concrete medium as low as possible. The presence of up to ½ percent gases is permissible, because at this level there is no expected or observable change in the compressive strength exhibited by the concrete that forms the structure. A measured gas generation of 3 cubic centimeters (cm³) per 50 grams of metal wires or fibers equates to an increase of ½ percent gas in a cement paste or concrete medium that contains a wire/fiber dosage of 70 lb/yd. Thus, the passivation of the zinc layer on the wires or fibers must be at or below this level for measured gas generation.

The integrity of the protective layer applied to the zinc passivation on the metal wire may be measured using at least one of two methods: 1) using a closed system designed to capture gas evolution in a graduated instrument from reaction that occurs with a 1 molar (M) potassium hydroxide solution having pH=14. and/or 2) immersing the wire with the protective layer in a 0.1% copper sulfate solution and inspecting for a color change from silver to black and measuring the rate of such color change.

### Method 1) KOH Test Set-Up

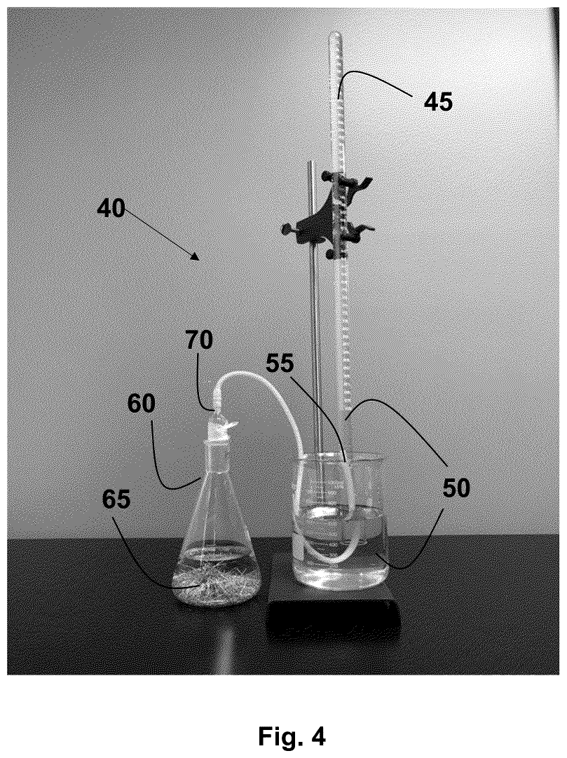

The KOH test set-up 40 is shown in FIG. 4. The following steps are conducted in the performance of this test method:
1) filling and then inverting an eudiometer 45 with about 650 ml of distilled water 50;
2) placing a ground glass stopper with open rubber tube 55 into the eudiometer 45;
3) tumbling together for 5 minutes in small rock tumbler: 150 grams pea gravel, 50 grams distilled water, and 50 grams of the protected zinc wire or fibers;
4) placing into a test vessel 60, the wires or fibers 65 from the tumbler and 300 grams of 1 M KOH (pH=14):
5) placing a stopper 70 into the test vessel and wrap the joint with parafilm;
6) reading the level of the water 50 in the eudiometer 45 and start the time;
7) reading the level every 15 minutes for a total of 2 hours; and
3) reporting the result in milliliters (ml) of water 50 displaced from the eudiometer. 45

Protected wires prepared according to the teachings of the present disclosure were tested accordingly. A total of 50 grams of the protected metal wires were observed produce less than or equal to 3.0 cubic centimeters (cm³) of a gas upon immersion in a 1 molar (M) potassium hydroxide solution (pH=14) for 90 minutes. In comparison, a total of fifty (50) grams of conventional wires comprising a metal core and a galvanized zinc layer were observed to produce greater than 3.0 cubic centimeters (cm³) of a gas upon immersion in a 1 molar (M) potassium hydroxide solution (pH=14) for 90 minutes.

### Method 2) In-Process Coating Test

In this test method, a copper sulfate (CuSO₄) stock solution (2%) is first prepared by performing the following steps:
1) put on safety equipment (gloves, glasses, lab coat);
2) place about 700 ml of water in to a 1-liter beaker;
3) measure out 20 grams of CuSO₄ pellets;
4) place a stir bar in the beaker and place on the stir plate with the stirrer turned on;
5) add slowly the CuSO₄ pellets to the stirring water until they are all dissolved;
6) retrieve the stir bar from the beaker (e.g., use a magnet for assistance);
7) place the reagent bottle on the scale and tare it;
8) using the funnel, pour the mixed CuSO₄ solution into the reagent bottle on the scale;
9) fill the reagent bottle with more distilled water until the mass is 1,000 grams; and
10) cap the bottle and swirl gently to mix the water into the CuSO₄ solution.

Next, a copper sulfate (CuSO₄) test solution (0.2%) is prepared by performing the following steps:
a) place the empty beaker on the scale;
b) measure 20 g of stock solution into the beaker; and
c) add 180 g of water to make 200 g total.

Finally, at least one wire or fiber, alternatively, a plurality of wires or fibers are placed into the test solution with any observable occurrence of a color change being reported. Protected wires prepared according to the teachings of the present disclosure were tested accordingly. The protected wires of the present disclosure were found to exhibit minimal color change, such that the rate of such change could not be estimated. In comparison, conventional wires comprising a metal core and a galvanized zinc layer were observed to exhibit a color change. More specifically, the zinc galvanization layer was observed to darken, while the blue copper sulfate solution became colorless indicating the occurrence of a spontaneous direct redox reaction.

### Corrosion Resistance

The application of a protective layer as described above and as further defined herein also has been found to reduce the corrosion rate of the wires or fibers upon exposure to multiple different solutions, including the following solutions: Lime (simulates fresh concrete), tap water (simulates aged carbonated concrete), Calcium Chloride solution (a common accelerator used for concrete) and NaCl solution (a salt solution used for de-icing). According to another aspect of the present disclosure, the metal wires exhibit a reduced rate of corrosion upon exposure to one or more of the lime/water mixture, tap water, CaCl solution or NaCl solution that is at least 5% less than the rate of corrosion exhibited by conventional uncoated steel wires, copper coated steel wires, or zinc-plated steel wires exposed to the same or identical conditions. Alternatively, the decrease in corrosion rate observed for the protected wires or fibers formed according to the teachings of the present disclosure as compared to conventional unprotected wires or fibers is greater than 7% alternatively, about 10% or more; alternatively, greater than 15%; alternatively, at least 20%; alternatively, in the range of about 5% to 25%.

The corrosion rate may be measured using a half cell reaction where pieces are embedded in concrete and corrosion current is measured. In addition, the rate of corrosion can be visually inspected and determined by observing the occurrence of corrosion to metal wires and fibers placed directly into such solutions.

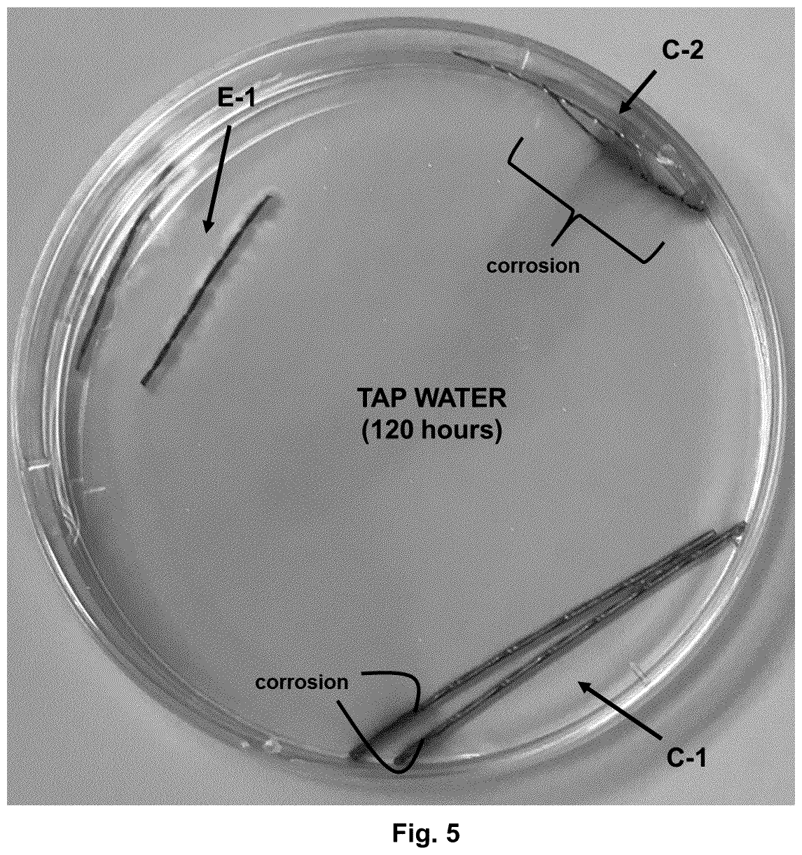

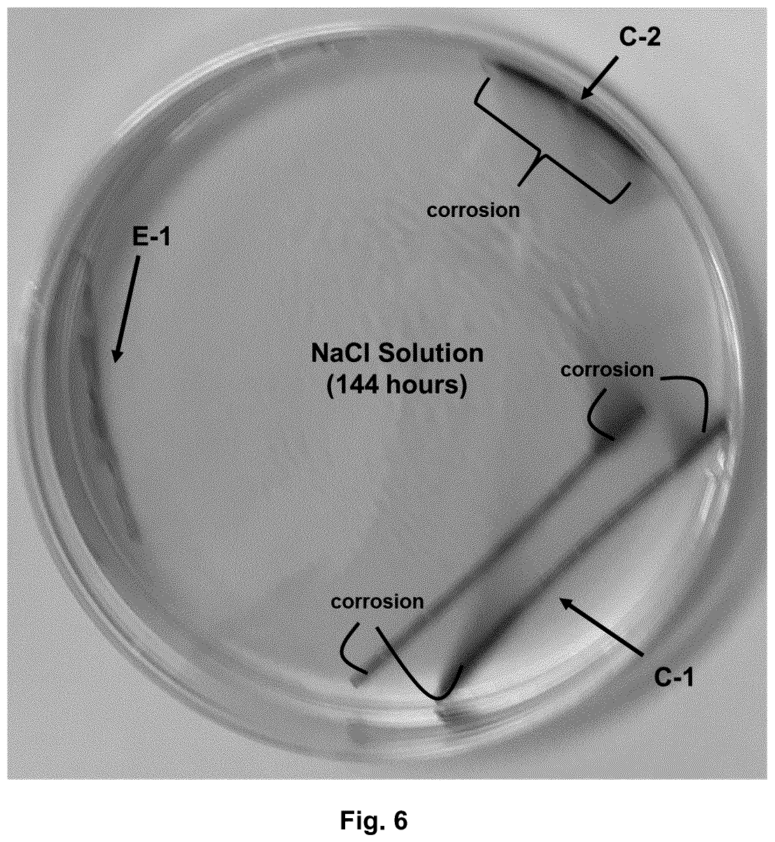

Referring now to FIGS. 5 and 6, metal wires were selected for testing that represent: (C-1) conventional galvanized wires or fibers comprising a steel core and a zinc galvanization layer; (C-2) steel wires or fibers whose surface is encapsulated in a copper layer; and (Ex-1) steel wires or fibers comprising a zinc galvanization layer protected during the wire or fiber drawing process with a dry-drawing agent according to the teachings of the present disclosure. Each of the wires or fibers were placed into a solution of either tap water to simulate exposure to aged carbonated concrete (FIG. 5) or a NaCl solution to simulate exposure to a de-icing solution (FIG. 6).

As shown in both FIGS. 5 and 6, all wires or fibers of C-1 and C-2 were observed to corrode substantially faster than the wires or fibers (EX-1) treated according to the process of the present disclosure. Observations were made after each 24 hour period for total exposure time of 144 hours. In each successive observation period the amount of corrosion for C-1 and C-2 wires or fibers gradually increased in both tap water and the salt solution, while corrosion of the wires or fibers in Ex-1 remained minimal. FIG. 5 demonstrates the occurrence of corrosion in tap water after 120 hours, while FIG. 6 shows the corrosion that occurs in a NaCl solution after 144 hours.

For the purpose of this disclosure the terms “about” and “substantially” are used herein with respect to measurable values and ranges due to expected variations known to those skilled in the art (e.g., limitations and variability in measurements).

For the purpose of this disclosure, the terms “at least one” and “one or more of” an element are used interchangeably and may have the same meaning. These terms, which refer to the inclusion of a single element or a plurality of the elements, may also be represented by the suffix “(s)” at the end of the element. For example, “at least one metal”, “one or more metals”, and “metal(s)” may be used interchangeably and are intended to have the same meaning.

Furthermore, any range in parameters that is stated herein as being “between [a 1^{st} number] and [a 2^{nd} number]” or “between [a 1^{st} number] to [a 2^{nd} number]” is intended to be inclusive of the recited numbers. In other words, the ranges are meant to be interpreted similarly as to a range that is specified as being “from [a 1^{st} number] to [a 2^{nd} number]”.

The specific examples provided in this disclosure are given to illustrate various embodiments of the invention and should not be construed to limit the scope of the disclosure. The embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

Those skilled-in-the-art, in light of the present disclosure, will appreciate that many changes can be made in the specific embodiments which are disclosed herein and still obtain alike or similar result without departing from or exceeding the spirit or scope of the disclosure. One skilled in the art will further understand that any properties reported herein represent properties that are routinely measured and can be obtained by multiple different methods. The methods described herein represent one such method and other methods may be utilized without exceeding the scope of the present disclosure.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

1. Metal wires for use in the reinforcement of a concrete structure, the metal wires comprising a metal core encapsulated by a galvanized layer of zinc with a protective passivation layer applied thereon,
wherein 50 grams of the metal wires produce less than or equal to 3.0 cubic centimeters (cm³) of a gas upon immersion in a 1 molar (M) potassium hydroxide solution (pH=14) for 90 minutes.

2. The metal wires according to claim 1, wherein the metal wires are subjected to abrasion by insertion into a rock tumbler having a 3:8 ratio of stone to water for at least 5 minutes without any degradation of the protective passivation layer, such that the amount of the gas produced by the wires remains less than or equal to 3.0 cm³ upon immersion in the potassium hydroxide solution.

3. The metal wires according to claim 1, wherein the metal wires are concrete reinforcing fibers or metal wire pieces configured for dispersion or mixing into a cement paste or concrete medium.

4. The metal wires according to claim 1, wherein the metal wires have an average diameter that is in the range of about 0.10 millimeters (mm) to about 2.00 mm and an average length that is less than or equal to 150 mm.

5. The metal wires according to claim 1, wherein the protective passivation layer comprises at least one dry-drawing agent that is sodium-based or calcium-based.

6. The metal wires according to claim 1, wherein 50 grams of the metal wires generate less than 3.0 cm³ of hydrogen (H₂) gas upon immersion into the cement paste or concrete medium.

7. The metal wires according to claim 1, wherein the metal wires when used to reinforce concrete allow the reinforced concrete to perform equal to or better than plain concrete in at least one of compressive testing (ASTM C39), flexural testing (ASTM C78), residual strength testing (ASTM C1399), post-crack beam testing (ASTM C1609), and freeze thaw testing (ASTM C666).

8. The metal wires according to claim 1, wherein the metal wires when used to reinforce concrete perform equal to or better than conventional concrete reinforcing fibers used in the same or identical fashion in direct tension testing.

9. The metal wires according to claim 1, wherein the metal wires exhibit a reduced rate of corrosion upon exposure to one or more of a lime/water mixture, tap water, a CaCl solution or a NaCl solution that is at least 5% less than the rate of corrosion exhibited by conventional uncoated steel wires, copper coated steel wires, or zinc-plated steel wires exposed to the same or identical conditions.

10. A twisted steel micro-reinforcement (TSMR) for use in providing reinforcement to a concrete structure, wherein the TSMR comprises one or more of the metal wires in accordance with claim 1.

11. Metal wires comprising a steel or iron core having a galvanized external surface with at least a portion the external surface being covered by a protective passivation layer;
wherein the metal wires exhibit a reduced rate of corrosion upon exposure to one or more of a lime/water mixture, tap water, a CaCl solution or a NaCl solution that is at least 5% less than the rate of corrosion exhibited by conventional uncoated steel wires, conventional copper-coated steel wires, or conventional zinc-plated steel wires exposed to the same or identical conditions.

12. The metal wires according to claim 11, wherein the metal wires are wire pieces, concrete reinforcing fibers, or TSMR configured for dispersion or mixing into a cement paste or concrete medium.

13. The metal wires according to claim 11, wherein the metal wires are configured such that 50 grams of the metal wires produces less than or equal to 3.0 cubic centimeters (cm³) of a gas upon immersion in a 1 molar (M) potassium hydroxide solution (pH=14) for 90 minutes.

14. The metal wires according to claim 13, wherein the metal wires are subjected to abrasion by insertion into a rock tumbler having a 3:8 ratio of stone to water for at least 5 minutes without any degradation of the protective passivation layer, such that the amount of the gas produced remains less than or equal to 3.0 cm³ upon immersion in the potassium hydroxide solution.

15. The metal wires according to claim 11, wherein 50 grams of the metal wires generate less than 3.0 cm³ of hydrogen (H₂) gas upon immersion into the cement paste or concrete medium.

16. The metal wires according to claim 11, wherein the metal wires when used to reinforce concrete allow the reinforced concrete to perform equal to or better than plain concrete in at least one of compressive testing (ASTM C39), flexural testing (ASTM C78), residual strength testing (ASTM C1399), post-crack beam testing (ASTM C1609), and freeze thaw testing (ASTM C666).

17. A process of manufacturing galvanized metal wires according to claim 1, wherein the process comprises:
forming metal wires having an external uncoated surface;
treating the external uncoated surface of the metal wires via electroplating or hot-dip galvanization, such that a layer of zinc is formed thereon; and
depositing a protective passivation layer on at least a portion of the layer of zinc.

18. The process according to claim 17, wherein depositing the protective passivation layer is done in-line with forming the metal wires and treating the external uncoated surface as a continuous process during the manufacturing of the metal wires.

19. The process according to claim 17, wherein at least one dry-drawing agent that is sodium-based or calcium-based is deposited as the protective passivation layer.

20. The process according to claim 19, wherein depositing the at least one dry-drawing agent is deposited onto the zinc layer upstream of any forming process used in the manufacturing process.
